(19) United States
(12) Patent Application Publication
(10) Pub. No.: US 2011/0157888 A1
(43) Pub. Date: Jun. 30, 2011

(54) SIDE-EMISSION TYPE LIGHTING DEVICE

(76) Inventor: Kevin Cho CHEN, Yongkang City (TW)

(21) Appl. No.: 12/977,452

(22) Filed: Dec. 23, 2010

(30) Foreign Application Priority Data
Dec. 31, 2009 (TW) 098146299

(51) Int. Cl. F21V 7/00; F21V 11/00

(52) U.S. Cl. 362/235

(57) ABSTRACT

A side-emission type lighting device includes a lamp seat, and a lighting unit disposed on the lamp seat. The lighting unit includes a mounting face that is perpendicular to a lamp axis, and at least one lighting element mounted on the mounting face for radiating emitted light away from the mounting face. The lighting device also includes a light-transmissive housing that surrounds and covers the lighting unit, that is disposed on the lamp seat, and that includes an end wall and a peripheral wall. The end wall is disposed distal to the lamp seat, and the peripheral wall extends from a periphery of the end wall towards the lamp seat. The lighting device also includes a light guide disposed between the light-transmissive housing and the lighting unit. The light guide includes a redirecting face that receives and redirects emitted light from the lighting element.

### CROSS-REFERENCE TO RELATED APPLICATION

This application claims priority of Taiwanese application no. 098146299, filed on Dec. 31, 2009.

### BACKGROUND OF THE INVENTION

1. Field of the Invention

The invention relates to a lighting device, and more particularly to a side-emission type lighting device.

2. Description of the Related Art

A conventional signal lamp, such as a brake light, a tail light, a directional light, a car light, a side light, a reverse gear light, a rear fog light, etc., may emanate signals for drivers of other vehicles to see. A type of conventional signal lamp, a “flash lamp,” may be configured to flash rapidly when activated, such as during an emergency. In order to accommodate a vehicle mount, the conventional “flash lamp” may be designed or mounted with less effective circuitry or with decreased heat dissipation capability. Accordingly, the conventional “flash lamp” may be improved.

### SUMMARY OF THE INVENTION

Therefore, an object of the present invention is to provide a side-emission type lighting device.

According to this invention, a side-emission type lighting device includes a lamp seat, and a lighting unit disposed on the lamp seat. The lighting unit includes a mounting face that is perpendicular to a lamp axis, and at least one lighting element mounted on the mounting face for radiating emitted light away from the mounting face. The side-emission type lighting device further includes a light-transmissive housing that surrounds and covers the lighting unit, that is disposed on the lamp seat, and that includes an end wall and a peripheral wall. The end wall is disposed distal to the lamp seat, and the peripheral wall extends from a periphery of the end wall towards the lamp seat. The side-emission type lighting device also includes a light guide disposed between the light-transmissive housing and the lighting unit. The light guide includes a redirecting face that receives emitted light from the at least one lighting element and redirects the emitted light out of the light-transmissive housing through the peripheral wall such that between 60 percent and 80 percent of the luminous flux of the emitted light from the at least one lighting element emerges from the light-transmissive housing at angles between 40 degrees and 80 degrees relative to the lamp axis.

An advantage of this invention includes the emission of light sideways while improving heat dissipation.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view of the first preferred embodiment of a side-emission type lighting device according to the present invention;

FIG. 2 is a partly sectional view of the first preferred embodiment;

FIG. 3 is a light distribution plot of the first preferred embodiment relative to a plane defined by a lamp axis and an emission axis;

FIG. 4 is a light distribution plot of the first preferred embodiment relative to a mounting face;

FIG. 5 is an exploded perspective view of the second preferred embodiment of the side-emission type lighting device according to the present invention;

FIG. 6 is a partly sectional view of the second preferred embodiment;

FIG. 7 is a light distribution plot of the second preferred embodiment relative to the plane defined by a lamp axis and an emission axis; and

FIG. 8 is a light distribution plot of the second preferred embodiment relative to the mounting face.

### DETAILED DESCRIPTION OF TEE PREFERRED EMBODIMENTS

Before the present invention is described in greater detail with reference to the accompanying preferred embodiment, it should be noted herein that like elements are denoted by the same reference numerals throughout the disclosure.

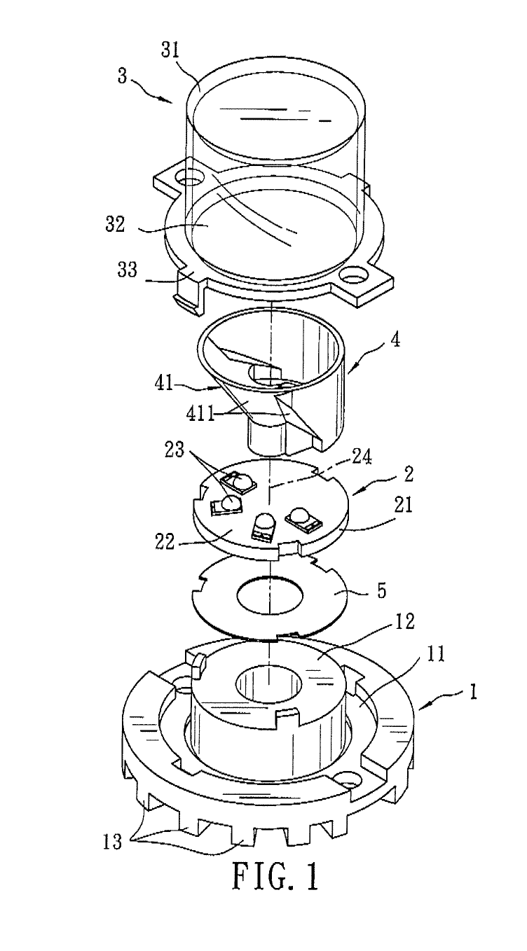

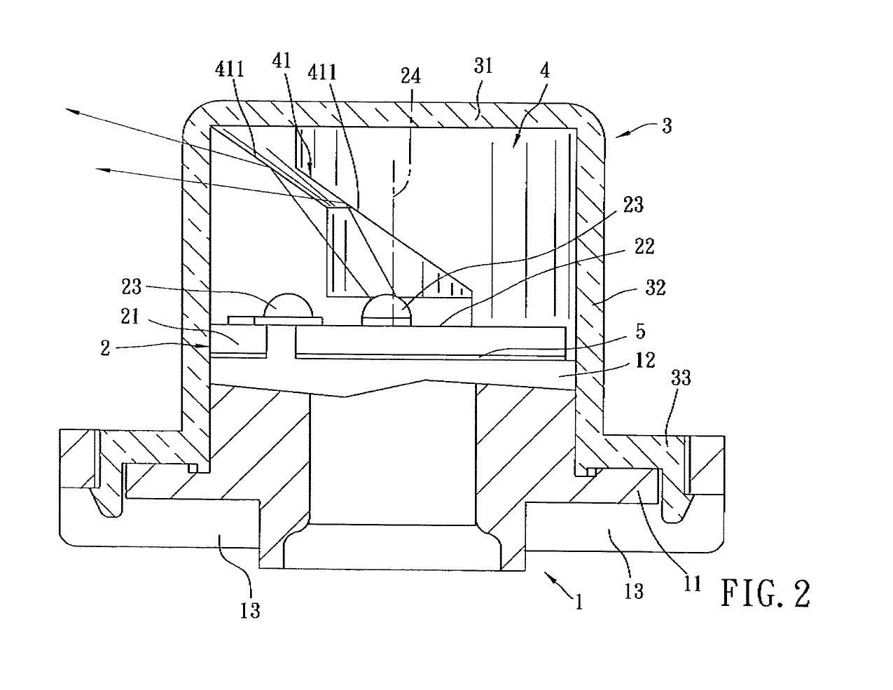

Referring to FIGS. 1 and 2, the first preferred embodiment of a side-emission type lighting device according to the present invention is shown to include a lamp seat 1, a lighting unit 2 mounted on the lamp seat 1, a heat-conductive silicone spacer 5 disposed between the lamp seat 1 and the lighting unit 2 to serve as a washer, a light-transmissive housing 3 covering the lighting unit 2, and a light guide 4 disposed between the light-transmissive housing 3 and the lighting unit 2. The disposition and mounting orientation of the side-emission type lighting device are not limited to what is disclosed in the preferred embodiment, and the lighting device may be disposed at any angle appropriate for a particular environment, such as being inverted, rotated by 90 degrees, or any other angle. The description below is based on what is shown in the Figures.

The lamp seat 1 is made of metal and includes an engaging portion 11, an elongate hollow cylindrical support portion 12 formed integrally with the engaging portion 11, and a plurality of spaced apart heat dissipating parts 13 formed on a bottom side of the engaging portion 11. The heat dissipating parts 13 can be used to provide additional surface area to improve heat dissipation effects.

The lighting unit 2 includes a circuit board 21 that is mounted on top of the support portion 12, and that has a circuit board face 22, which serves as a mounting face. The lighting unit 2 further includes four lighting elements 23 mounted on the circuit board face 22 for emitting light, and has a lamp axis 24 extending perpendicularly from the circuit board face 22 and parallel to an emitting direction of the emitted light. Each of the lighting elements 23 is a light emitting diode in this embodiment. The number of lighting elements 23 may be increased or decreased according to need, such as 1, 3, 4, 8, 12, etc. Because the designs of the connecting circuits and relevant switches of the circuit board 21 and the lighting elements 23 are not the focus of this invention, they are not further described for the sake of brevity.

The heat-conductive silicone spacer 5 is a washer with good heat conduction properties and has a thickness of 0.5 mm. The heat-conductive silicone spacer 5 is adhered between the support portion 12 and the circuit board 21 to seal a space between the support portion 12 and the circuit board 21 and to closely mount the lighting unit 2 to the lamp seat 1.

The light-transmissive housing 3 is made of light-transmissive plastic material, and includes an end wall 31 disposed above and spaced apart from the lighting unit 2 (e.g., distal to the lamp seat 1), a peripheral wall 32 extending downward from a periphery of the end wall 31, and a cover flange 33 extending radially outward from a bottom of the peripheral wall 32 to be fixedly connected to the lamp seat 1. The light-transmissive housing 3 and the lamp seat 1 may be coupled together, and may be independently or cooperatively fastened to a vehicle light (not shown).

The light guide 4 according to the first embodiment includes a reflective structure 41 that includes a mirror for receiving emitted light from the lighting elements 23 and redirecting the emitted light sidewise out of the light-transmissive housing 3. The emitted light may be redirected out through the peripheral wall 32 of the light-transmissive housing 3. The reflective structure 41 faces toward an exterior environment and extends in a direction inclined relative to the lamp axis 24. The reflective structure 41 is disposed above the lighting elements 23, and includes a plurality of reflective surfaces 411 having different angles and connected to one another for reflecting light.

The reflective surfaces 411 of the reflective structure 41 receive emitted light from the lighting elements 23 that is directed parallel to the lamp axis 24. The reflective surfaces 411 then redirect the emitted light in a direction that is angled relative to the lamp axis 24. The quantity, angles, and curvatures of the reflective surfaces 411 of the reflective structure 41 may be varied in different embodiments according to the particular distribution of emitted light from a particular set of lighting elements 23, and therefore are not limited to the disclosed embodiments. Referring to FIG. 2, the lighting elements 23 emit light directly to the reflective structure 41 without intervening structures. The emitted light is then reflected by the reflective surfaces 411 of the reflective structure 41 sideways through the peripheral wall 32 of the light-transmissive housing 3 and away from the reflective structure 41.

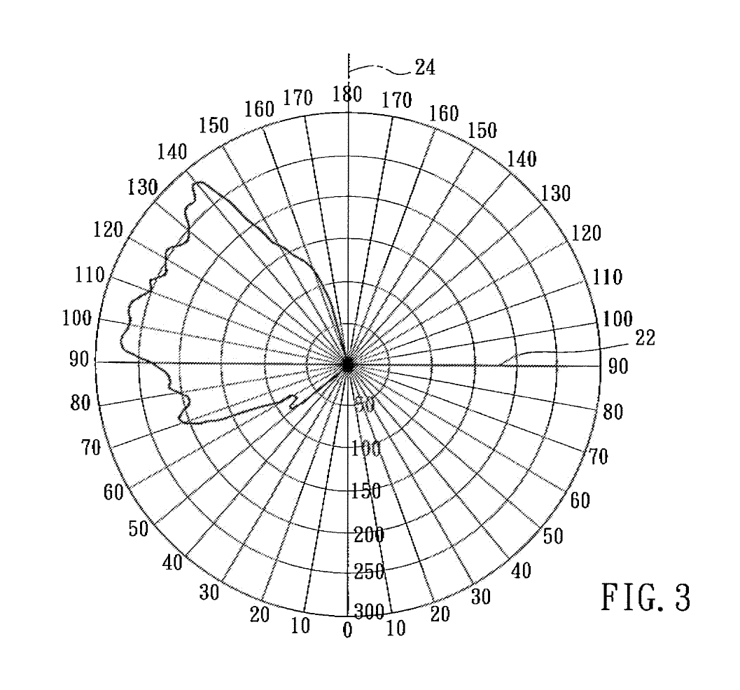

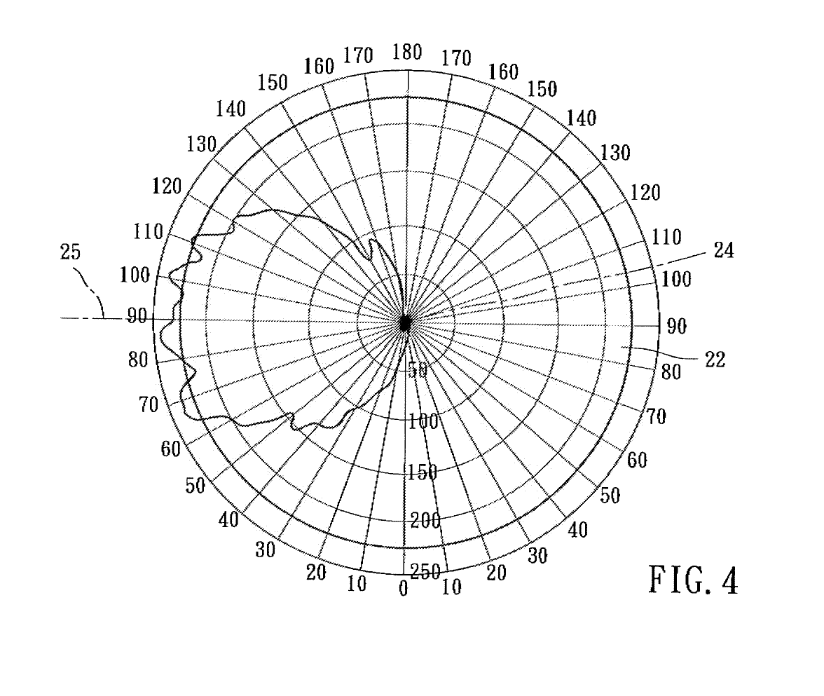

FIGS. 3 and 4 illustrate light distribution plots of this embodiment obtained from tests made by the applicant. In the light distribution plots, the straight longitudinal lines represent the angles in degrees, whereas the concentric latitudinal lines represent the strength of the light measured in cd/klm (candela/kilo lumen). FIG. 3 illustrates the mounting face 22 placed on the line from 90° to 90°, with the lamp axis 24 extending through the line from 0° to 180°. In FIG. 3, part of the luminous flux of the emitted light is distributed between the range of 80°-140°, or in other words, deviate from the lamp axis 24 at angles ranging between 40° and 80°. FIG. 4 illustrates the mounting face 22 centered and oriented parallel to the plot, with the lamp axis 24 extending through the center point. In FIG. 4, the emitted light is distributed across the range of 10°-170°, or in other words, an angular range spanning 160° that is centered at an emitting axis 25. FIGS. 3 and 4 therefore indicate that light is emitted sidewise from the light-transmissive housing 3, and that 60%-80% of the overall emitted light is redirected laterally at angles between 40°˜80° relative to the lamp axis 24.

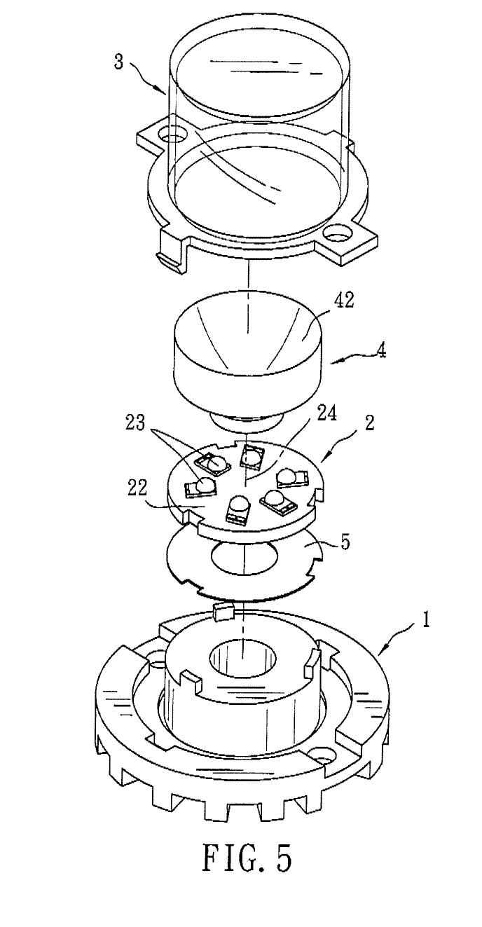

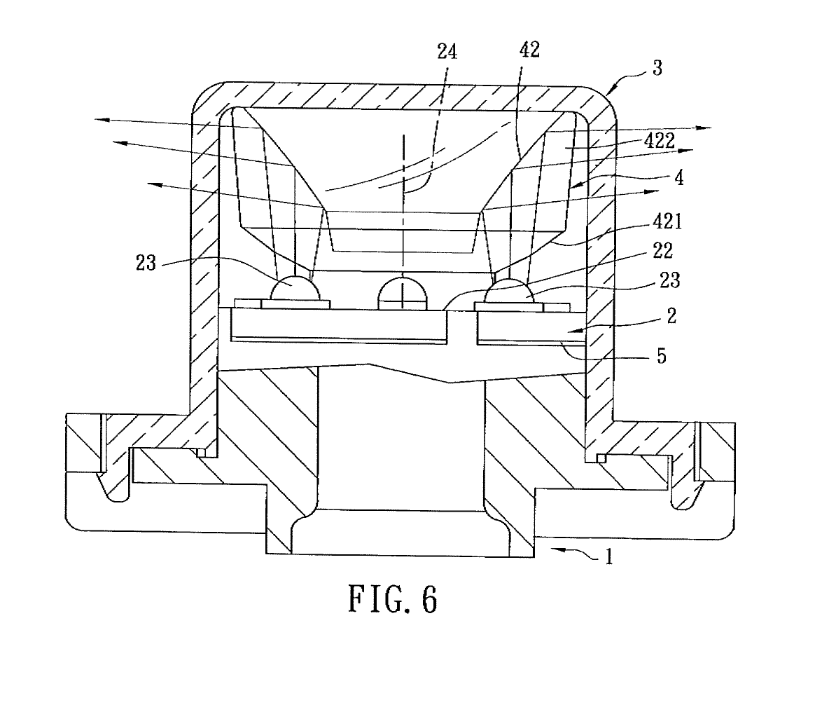

Referring to FIGS. 5 and 6, the second preferred embodiment of a side-emission type lighting device according to the present invention includes a lamp seat 1, a lighting unit 2, a heat-conductive silicone spacer 5, a light-transmissive housing 3 and a light guide 4. The second preferred embodiment differs from the first preferred embodiment in that the light guide 4 is a reflective prism that includes an angled face 42 facing the exterior environment and extending in a direction inclined to the lamp axis 24. Emitted light from the lighting elements 23 passes through a light entrance face 421 of the light guide 4, is reflected by the angled face 42, and passes through a light exit face 422 of the light guide 4 before exiting out of the light-transmissive housing 3 through the peripheral wall 32. The angled face 42 is a conic face in this embodiment.

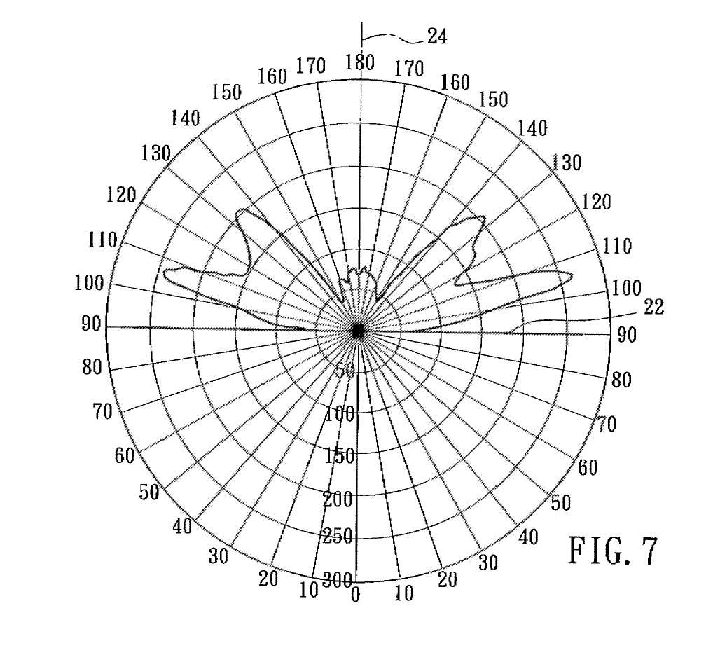

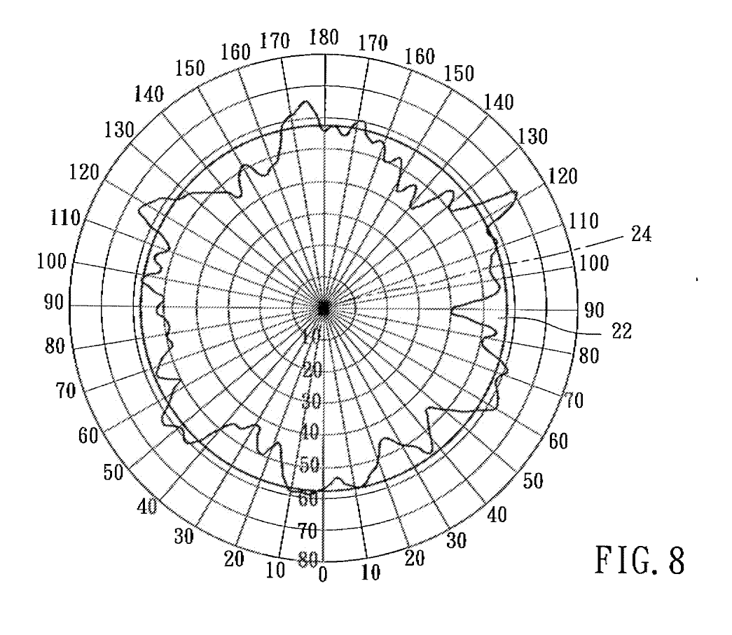

FIGS. 7 and 8 illustrate light distribution plots of the second preferred embodiment obtained from tests made by the applicant. FIG. 7 illustrates the mounting face 22 placed on the line from 90° to 90°, with the lamp axis 24 extending through the line from 0° to 180°. As shown in FIG. 7, part of the luminous flux of the emitted light is distributed between the range of 100°-140°, or in other words, deviate from the lamp axis 24 at angles ranging between 40° and 80°. FIG. 8 illustrates the mounting face 22 centered and oriented parallel to the plot, with the lamp axis 24 extending through the center point. In FIG. 8, the emitted light radiates outward 360° from the light axis 24 at the center of the plot.

FIG. 7 shows that the emitted light is further distributed across a range of 40°-80° deviated away from the lamp axis 24. 60%-80% of the overall emitted light is distributed sideways away from the lamp axis 24.

In summary, by mounting the light guide 4 between the light-transmissive housing 3 and the lighting unit 2, and through the structural design and disposition of the light guide 4, the emitted light originally directed towards the end wall 31 is redirected sideways out of the light-transmissive housing 3 without altering the mounting position of the lighting elements 23 or the design of the circuits of the circuit board 21. Good heat dissipation effect is therefore still maintained.

While the present invention has been described in connection with what are considered the most practical and preferred embodiments, it is understood that this invention is not limited to the disclosed embodiments but is intended to cover various arrangements included within the spirit and scope of the broadest interpretation to encompass all such modifications and equivalent arrangements.

What is claimed is:

1. A side-emission type lighting device comprising:
a lamp seat;
a lighting unit disposed on said lamp seat and including a mounting face that is perpendicular to a lamp axis, and at least one lighting element mounted on said mounting face for radiating emitted light away from said mounting face;
a light-transmissive housing surrounding and covering said lighting unit, being disposed on said lamp seat, and including an end wall and a peripheral wall, said end wall being disposed distal to said lamp seat, said peripheral wall extending from a periphery of said end wall towards said lamp seat; and
a light guide disposed between said light-transmissive housing and said lighting unit, said light guide including a redirecting face that receives emitted light from said at least one lighting element and redirects the emitted light out of said light-transmissive housing through said peripheral wall such that between 60 percent and 80 percent of the luminous flux of the emitted light from said at least one lighting element emerges from said light-transmissive housing at angles between 40 degrees and 80 degrees relative to the lamp axis.

2. The side-emission type lighting device as claimed in claim 1, wherein said light guide includes a mirror having a reflective surface that forms said redirecting face and that extends at an angle relative to the lamp axis.

3. The side-emission type lighting device as claimed in claim 1, wherein said light guide includes a reflective prism having a light entrance face, an angled face that forms said redirecting face, and a light exit face, wherein said angled face extends at an angle relative to the lamp axis, and wherein emitted light from said at least one lighting element passes through said light entrance face, is reflected by said angled face, and passes through said light exit face before exiting out of said light-transmissive housing through said peripheral wall.

4. The side-emission type lighting device as claimed in claim 1, wherein said lighting unit further includes a circuit board having said mounting face, said circuit board being disposed on said lamp seat.

5. The side-emission type lighting device as claimed in claim 1, wherein said lamp seat includes a support portion and an engaging portion that is integrally formed with a base of said support portion, said lighting unit being disposed on said support portion, said light-transmissive housing being engaged with said engaging portion.

6. The side-emission type lighting device as claimed in claim 5, wherein said lamp seat further includes a plurality of spaced-apart heat dissipating parts formed on one side of said engaging portion opposite said light-transmissive housing.

7. The side-emission type lighting device as claimed in claim 1, further comprising a spacer made of a heat-conductive and electrically insulating material and disposed between said lamp seat and said lighting unit.

8. The side-emission type lighting device as claimed in claim 7, wherein said spacer is made of silicone.

9. The side-emission type lighting device as claimed in claim 1, wherein said lighting element of said lighting unit is a light emitting diode.
